(19) United States
(12) Patent Application Publication
(10) Pub. No.: US 2015/0036384 A1
(43) Pub. Date: Feb. 5, 2015

(54) LIGHT EMITTING MODULE AND BACKLIGHT ASSEMBLY HAVING THE SAME

(71) Applicant: Samsung Display Co., Ltd., Yongin-City (KR)

(72) Inventors: Young-Min PARK, Hwaseong-si (KR); Young-Chun KIM, Seoul (KR); Seok-Hyun NAM, Seoul (KR); Se-Ki PARK, Hwaseong-si (KR); Jung-Hoon SHIN, Seongnam-si (KR); Jung-Hyun YANG, Hwaseong-si (KR)

(73) Assignee: Samsung Display Co., Ltd., Yongin-City (KR)

(21) Appl. No.: 14/264,336

(22) Filed: Apr. 29, 2014

(30) Foreign Application Priority Data
Aug. 2, 2013 (KR) 10-2013-0091939

(51) Int. Cl. F21V 29/00; F21V 8/00; F21V 9/08

(52) U.S. Cl. CPC F21V 29/004; F21V 9/08; G02B 6/0068
USPC 362/613; 362/249.01; 362/235

(57) ABSTRACT

A light emitting module includes a first and second light source spaced apart from each other and each configured to generate and emit light; the first light source; and a metal board which is electrically connected to the first and second light sources. The metal board includes a body portion upon which the first and second light sources are disposed; first and second side portions respectively on first and second ends of the body portion; a first insulation layer which is between the body portion and the first side portion and insulates the body portion from the first side portion; and a second insulation layer which is between the body portion and the second side portion and insulates the body portion from the second side portion.

This application claims priority to Korean Patent Application No. 10-2013-0091939, filed on Aug. 2, 2013, and all the benefits accruing therefrom under 35 U.S.C. §119, the contents of which are herein incorporated by reference in their entireties.

### BACKGROUND

1. Field

Exemplary embodiments of the invention relate to a light emitting module and a backlight assembly having the light emitting module. More particularly, exemplary embodiments of the invention relate to a light emitting module improving a heat dissipation of a backlight assembly and a backlight assembly having the light emitting module.

2. Description of the Related Art

A flat panel display (“FPD”) may be used as a display apparatus. The FPD may be a relatively large, thin and/or lightweight display device. Examples of the FPD include, but are not limited to, a liquid crystal display (“LCD”), a plasma display panel (“PDP”), and the display apparatus uses a light emitting diode (“LED”) as a light source.

The display apparatus includes a LED package as a light source. The LED package includes a plurality of LEDs in one LED package to thereby decrease a size of the LED package.

As the number of the LEDs is increased in the LED package, heat generated from the LED package is increased.

### SUMMARY

One or more exemplary embodiment of the invention provides a light emitting module capable of improving a heat dissipation of a backlight assembly.

One or more exemplary embodiment of the invention also provides a backlight assembly having the light emitting module.

According to an exemplary embodiment, a light emitting module includes a first light source, a second light source and a metal board. The metal board includes a body portion, a first side portion, a second side portion, a first insulation layer and a second insulation layer. The first light source and the second light source emit light. The second light source is spaced apart from the first source. The first light source and the second light source are on the body portion. The first side portion is on a first end of the body portion. The second side portion is on a second end of the body portion opposite to the first end of the body portion. The first insulation layer is between the body portion and the first side portion, and electrically insulates the body portion from the first side portion. The second insulation layer is between the body portion and the second side portion, and electrically insulates the body portion from the second side portion.

In an exemplary embodiment, the light emitting module may further include an insulation film on a surface of the metal board opposite a surface of the metal board on which the first light source and the second light source are disposed.

In an exemplary embodiment, the light emitting module may further include a sealing material covering the first light source and the second light source, and converting a chromaticity of the light emitted by the first light source and the second light source. The sealing material is on the first light source, the second light source and the metal board.

In an exemplary embodiment, the body portion may include a first inner insulation layer and a second insulation layer, where the first inner insulation layer and the second insulation layer divide the body portion into plural portions. The first light source may include a first electrode and a second electrode between a light emitting portion and the body portion. The second light source may include a first electrode and a second electrode between a light emitting portion and the body portion. The first electrode of the first light source is electrically connected to a portion of the body portion between the first insulation layer and the first inner insulation layer. The second electrode of the first light source is electrically connected to a portion of the body portion between the first inner insulation layer and the second inner insulation layer. The first electrode of the second light source is electrically connected to the portion of the body portion between the first inner insulation layer and the second inner insulation layer. The second electrode of the second light source is electrically connected to a portion of the body portion between the second inner insulation layer and the second insulation layer.

In an exemplary embodiment, the body portion may further include a first source electrode on the portion of the body portion between the first insulation layer and the first inner insulation layer, and a second source electrode on the portion of the body portion between the second inner insulation layer and the second insulation layer. The first source electrode receives a first power voltage. The second source electrode receives a second power voltage.

In an exemplary embodiment, a width of the first side portion and a width of the second side portion are greater than a width of the body portion. An extending direction of the width of the first side portion, an extending direction of the width of the second side portion and an extending direction of the width of the body portion are parallel with extending directions of the first insulation layer and the second insulation layer.

In an exemplary embodiment, the first inner insulation layer and the second inner insulation layer are parallel with the first insulation layer and the second insulation layer, and are sequentially arranged at constant intervals.

In an exemplary embodiment, the light emitting module may further include a third light source emitting light, between the first light source and the second light source, and spaced apart from the first light source and the second light source. The third light source may include a first electrode and a second electrode at a distal end of a light emitting portion of the third light source. The body portion may further include a third inner insulation layer between the first inner insulation layer and the second inner insulation layer. The third inner insulation layer is parallel with the first inner insulation layer and the second inner insulation layer, and divides the body portion between the first inner insulation layer and the second inner insulation layer into the plural portions. The first electrode of the third light source is electrically connected to a portion of the body portion between the first inner insulation layer and the third inner insulation layer. The second electrode of the third light source is electrically connected to a portion of the body portion between the second inner insulation layer and the third inner insulation layer.

In an exemplary embodiment, the first light source may include a first electrode and a second electrode at a distal end of a light emitting portion. The second light source may include a first electrode and a second electrode at a distal end of a light emitting portion. The first electrode of the first light source is electrically connected to the first side portion with a first conductive connection member. The second electrode of the first light source is electrically connected to the first electrode of the second light source with a second conductive connection member. The second electrode of the second light source is electrically connected to the second side portion with a third conductive connection member.

In an exemplary embodiment, the metal board may further include a first source electrode on the first side portion; and a second source electrode on the second side portion. The first source electrode receives a first power voltage, and the second source electrode receives a second power voltage.

In an exemplary embodiment, a width of the first side portion and a width of the second side portion are less than a width of the body portion. An extending direction of the width of the first side portion, an extending direction of the width of the second side portion and an extending direction of the width of the body portion are parallel with extending directions of the first insulation layer and the second insulation layer.

In an exemplary embodiment, the metal board may further include a third side portion on an end portion of the first side portion, a third insulation layer between the first side portion and the third side portion, and electrically insulating the third side portion from the first side portion, a fourth side portion on an end portion of the second side portion and a fourth insulation layer between the second side portion and the fourth side portion, and electrically insulating the fourth side portion from the second side portion.

In an exemplary embodiment, the light emitting module may further include a third light source emitting light, between the first light source and the second light source, and spaced apart from the first light source and the second light source. The first light source, the second light source and the third light source may each include a first electrode and a second electrode at a distal end of a light emitting portion. The first electrode of the first light source is electrically connected to the first side portion with a first conductive connection member. The second electrode of the first light source is electrically connected to the first electrode of the third light source with a second conductive connection member. The second electrode of the third light source is electrically connected to the first electrode of the second light source with a third conductive connection member. The second electrode of the second light source is electrically connected to the second side portion with a fourth conductive connection member.

According to an exemplary embodiment, a backlight assembly includes a light emitting module, a light guide plate, an extrusion bar securing the light emitting module. The light emitting module includes a first light source emitting light, a second light source emitting light and spaced apart from the first light source, a metal board electrically connected with the first light source and the second light source, an insulation film on a surface of the metal board opposite a surface of the metal board on which the first light source and the second light source are disposed, and a sealing material covering the first light source and the second light source, and converting a chromaticity of the light emitted by the first light source and the second light source. The light guide plate includes a light incident surface and a light exiting surface. The metal board includes a body portion on which the first light source and the second light source are disposed, a first side portion on a first end of the body portion, a second side portion on a second end of the body portion opposite to the first end of the body portion, a first insulation layer between the body portion and the first side portion, and electrically insulating the body portion from the first side portion, and a second insulation layer between the body portion and the second side portion, and electrically insulating the body portion from the second side portion.

In an exemplary embodiment, the body portion may include a first inner insulation layer and a second inner insulation layer. The first inner insulation layer and the second inner insulation layer divide the body portion into plural portions. The first light source and the second light source include a first electrode and a second electrode between a light emitting portion and the body portion. The first electrode of the first light source is electrically connected to a portion of the body portion between the first insulation layer and the first inner insulation layer. The second electrode of the first light source is electrically connected to a portion of the body portion between the first inner insulation layer and the second inner insulation layer. The first electrode of the second light source is electrically connected to the portion of the body portion between the first inner insulation layer and the second inner insulation layer. The second electrode of the second light source is electrically connected to a portion of the body portion between the second inner insulation layer and the second insulation layer.

In an exemplary embodiment, the body portion may further include a first source electrode on the portion of the body portion between the first insulation layer and the first inner insulation layer, and a second source electrode on the portion of the body portion between the second insulation layer and the second inner insulation layer. The first source electrode receives a first power voltage. The second source electrode receives a second power voltage.

In an exemplary embodiment, a width of the first side portion and a width of the second side portion are greater than a width of the body portion. An extending direction of the width of the first side portion, an extending direction of the width of the second side portion and an extending direction of the width of the body portion are parallel with extending directions of the first insulation layer and the second insulation layer.

In an exemplary embodiment, the first light source and the second light source may include a first electrode and a second electrode at a distal end of a light emitting portion. The first electrode of the first light source is electrically connected to the first side portion with a first conductive connection member. The second electrode of the first light source is electrically connected to the first electrode of the second light source with a second conductive connection member. The second electrode of the second light source is electrically connected to the second side portion with a third conductive connection member.

In an exemplary embodiment, the metal board may further include a first source electrode on the first side portion, and a second source electrode on the second side portion. The first source electrode receives a first power voltage. The second source electrode receives a second power voltage.

In an exemplary embodiment, a width of the first side portion and a width of the second side portion are less than a width of the body portion. An extending direction of the width of the first side portion, an extending direction of the width of the second side portion and an extending direction of the width of the body portion are parallel with extending directions of the first insulation layer and the second insulation layer.

According to one or more exemplary embodiment of the light emitting module and the backlight assembly having the light emitting module, a heat dissipation of the backlight assembly may be improved.

### BRIEF DESCRIPTION OF THE DRAWINGS

The above and other features and advantages of the invention will become more apparent by describing in detailed exemplary embodiments thereof with reference to the accompanying drawings, in which:

FIG. 1 is an exploded perspective view illustrating an exemplary embodiment of a display apparatus in accordance with the invention;

FIG. 2 is a perspective view illustrating an exemplary embodiment of a light emitting module in accordance with the invention;

FIG. 3 is a cross-sectional view taken along line II-II′ in FIG. 2;

FIG. 4 is a cross-sectional view illustrating portion ‘A’ in FIG. 3;

FIG. 5 is a cross-sectional view taken along line I-I′ in FIG. 1 in accordance with the invention;

FIG. 6 is a perspective view illustrating another exemplary embodiment of a light emitting module in accordance with the invention;

FIG. 7 is a cross-sectional view taken along line III-III′ in FIG. 6;

FIG. 8 is a cross-sectional view illustrating a portion ‘B’ in FIG. 7; and

FIG. 9 is another exemplary embodiment of a cross-sectional view taken along line I-I′ in FIG. 1 in accordance with the invention.

### DETAILED DESCRIPTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on” or “connected to” another element or layer, the element or layer can be directly on or connected another element or layer or intervening elements or layers. In contrast, when an element is referred to as being “directly on” and “directly connected to” another element or layer, there are no intervening elements or layers present. As used herein, connected may refer to elements being physically and/or electrically connected to each other. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Spatially relative terms, such as “below,” “lower,” “under,” “above,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” relative to other elements or features would then be oriented “above” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used in this specification, specify the presence of stated features, integers, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the invention will be explained in detail with reference to the accompanying drawings.

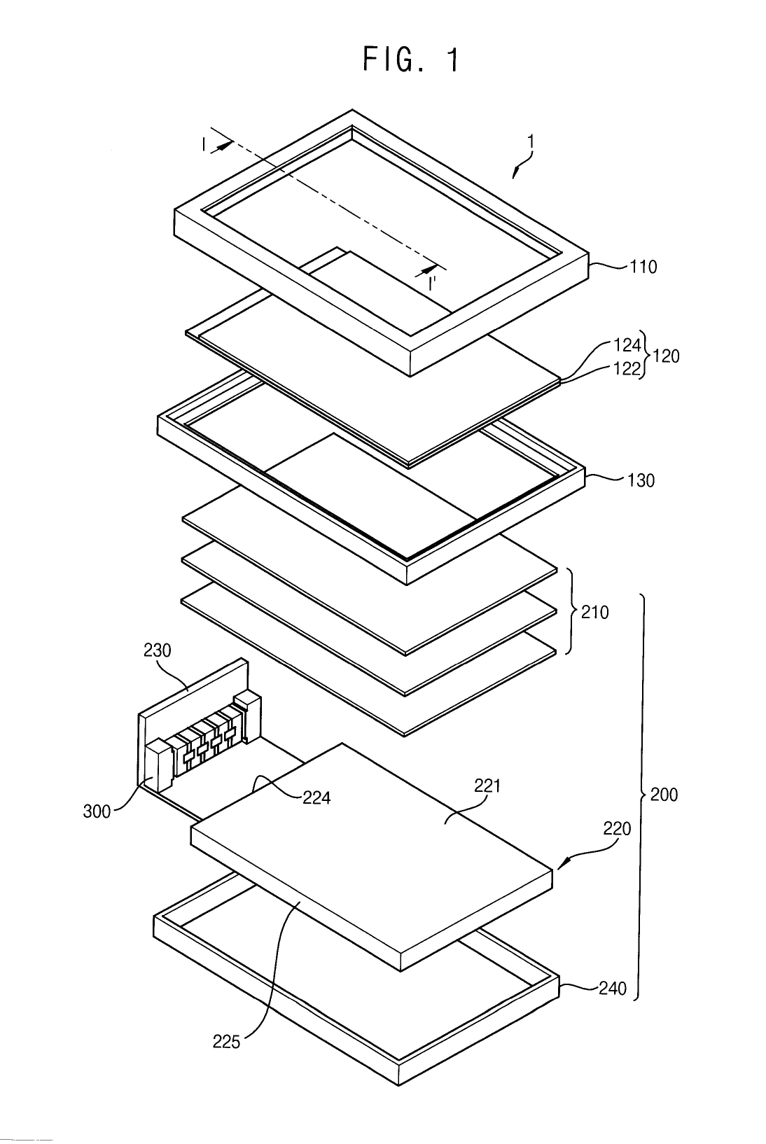

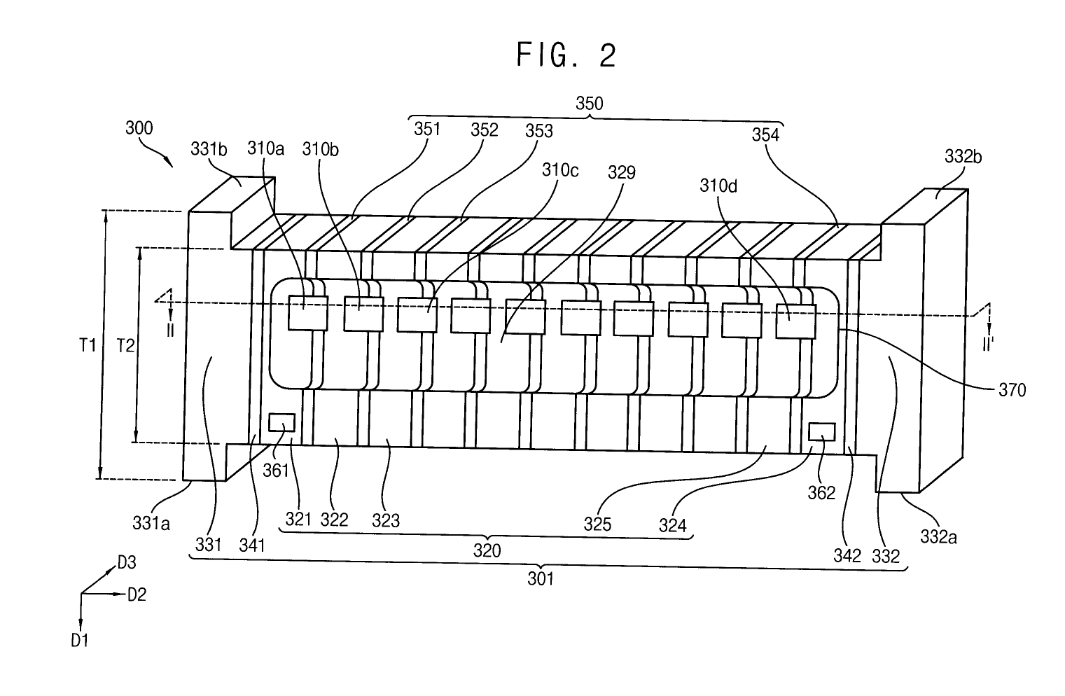

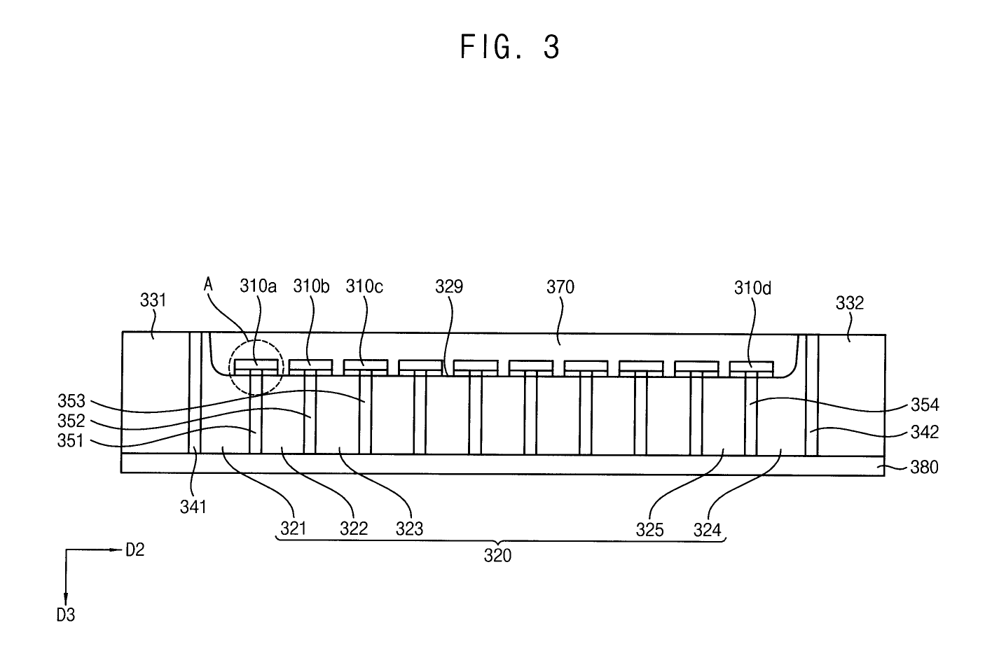

FIG. 1 is an exploded perspective view illustrating an exemplary embodiment of a display apparatus in accordance with the invention. FIG. 2 is a perspective view illustrating an exemplary embodiment of a light emitting module in accordance with the invention. FIG. 3 is a cross-sectional view taken along line II-II′ in FIG. 2.

Referring to FIGS. 1 to 3, a display apparatus 1 includes an upper receiving container 110, a display panel 120, mold frame 130 and a backlight assembly 200.

The upper receiving container 110 may be disposed over the display panel 120. The upper receiving container 110 may protect the display panel 120 from an external impact. An opening may be extended through a thickness of the upper receiving container 110 to expose a display area of the display panel 120.

The display panel 120 may include a thin-film transistor substrate 122, a color filter substrate 124, and a liquid crystal layer (not shown). The thin-film transistor substrate 122 may include a first base substrate, a thin-film transistor and a pixel electrode. The color filter substrate 124 may face the thin-film transistor substrate 122 and may include a second base substrate, a color filter and a common electrode. The liquid crystal layer may be interposed between the thin-film transistor substrate 122 and the color filter substrate 124. An alignment of a liquid crystal molecule of the liquid crystal layer may be controlled by an electric field generated between the pixel electrode of the thin-film transistor substrate 122 and the common electrode of the color filter substrate 124. The display panel 120 may display an image using light exiting from a light exiting surface 221 of a light guide plate 220 of the backlight assembly 200.

The backlight assembly 200 may be disposed under the display panel 120 to generate and provide the light to the display panel 120.

The backlight assembly 200 includes the light guide plate 220, optical sheets 210, a reflection sheet 250, a light emitting module 300, an extrusion bar 230 and a lower receiving container 240.

The light guide plate 220 may be disposed at a side of the light emitting module 300. The light guide plate 220 may include a light incident surface into which light is incident and the light exiting surface 221 through which light exits. The light guide plate 220 may include a relatively shorter side 224, a relatively longer side 225 and a corner (not shown) at which the sides 224 and 225 meet. The relatively shorter side 224 extends in a direction substantially parallel with a relatively shorter side of the display panel 120. The relatively longer side 225 extends in a direction substantially parallel with a relatively longer side of the display panel 120. The corner may be a region between the relatively shorter side 224 and the relatively longer side 225 of the light guide plate 220 and at which ends of the relatively shorter side surface 224 and the relatively longer side surface 225 are connected to each other.

The light emitting module 300 may face at least one side surface of the light guide plate 220. In one exemplary embodiment, for example, the light emitting module 300 may face at least one of the relatively shorter side 224, the relatively longer side 225 and the corner of the light guide plate 220. Alternatively, the light emitting module 300 may be flexible, and thus the light emitting module 300 may extend from an area facing the corner to an area facing the relatively shorter side 224, and/or the light emitting part 210 may extend from the area facing the corner to an area facing the relatively longer side 225.

The optical sheets 210 may be disposed over the light guide plate 220. The optical sheets 210 may enhance an efficiency of the light exiting from the light guide plate 220. The optical sheets 210 may include a diffusion sheet, a prism sheet and/or a light-condensing sheet.

The reflection sheet 250 may be disposed between the light guide plate 220 and the extrusion bar 230. The reflection sheet 250 may reflect light leaking from the light emitting module 300 and from the light guide plate 220.

The light emitting module 300 includes a board 301 including a metal material, one or more light source and an insulation film 380.

The light source may be secured to the metal board 301, and may be electrically connected to the metal board 301. The metal board 301 includes a body portion 320, a first side portion 331, a second side portion 332, a first insulation layer 341, and a second insulation layer 342.

The light source may be disposed on the body portion 320. The first side portion 331 may be disposed on a first end of the body portion 320, and the second side portion 332 may be disposed on a second end of the body portion 320. The second end of the body portion 320 is opposite to the first end of the body portion 320.

The first insulation layer 341 may be disposed between the body portion 320 and the first side portion 331. The first insulation layer 341 may electrically insulate the body portion 320 from the first side portion 331. The second insulation layer 342 may be disposed between the body portion 320 and the second side portion 332. The second insulation layer 342 may electrically insulate the body portion 320 from the second side portion 332.

The body portion 320 may include an inner insulation member 350 including a plurality of inner insulation layers. The inner insulation layers of the inner insulation member 350 may divide the body portion 320 into plural portions. The inner insulation layers of the inner insulation member 350 may be parallel with the first insulation layer 341 and the second insulation layer 342 and may be sequentially arranged at constant intervals, and thus divide the body portion 320 into the plural portion. The portions of the body portion 320 may be electrically insulated from an adjacent portion of the body portion 320, respectively.

The inner insulation member 350 may include a first inner insulation layer 351 adjacent to the first insulation layer 341, a second inner insulation layer 352, a third inner insulation layer 353, . . . , and a n-th inner insulation layer 354 adjacent to the second insulation layer 342.

The first to n-th inner insulation layers of the inner insulation member 350 may be spaced apart from one another along a length direction of the metal board 301.

The first insulation layer 341, the second insulation layer 342, . . . , and the n-th inner insulation layer 354 may include an insulating material such as polyimide.

The plural portions of the body portion 320 divided by the inner insulation layers of the inner insulation member 350 may include a first portion 321 of the body portion, a second portion 322 of the body portion, a third portion 323 of the body portion, . . . , and a (n+1)-th portion 324 of the body portion.

The first portion 321 is disposed between the first insulation layer 341 and the first inner insulation layer 351. The second portion 322 is disposed between the first inner insulation layer 351 and the second inner insulation layer 352. The third portion 323 is disposed between the second inner insulation layer 352 and the third inner insulation layer 353. The (n+1)-th portion 324 is disposed between the second insulation layer 342 and the n-th inner insulation layer 354.

The first portion 321 is separated from the first side portion 331 by the first insulation layer 341, thus the first portion 321 is electrically insulated from the first side portion 331. The first portion 321 is separated from the second portion 322 by the first inner insulation layer 351, thus the first portion 321 is electrically insulated from the second portion 322.

The second portion 322 is separated from the third portion 323 by the second inner insulation layer 352, thus the second portion 322 is electrically insulated from the third portion 323.

The (n+1)-th portion 324 is separated from the second side portion 332 by the second insulation layer 342, thus the (n+1)-th portion 324 is electrically insulated from the second side portion 332. The (n+1)-th portion 324 is separated from an n-th portion 325 by the n-th inner insulation layer 354, thus the (n+1)-th portion 324 is electrically insulated from the n-th portion 325.

The first portion 321 may further include a first source electrode 361. The first source electrode 361 may receive a first power voltage from a driver part (not shown).

The (n+1)-th portion 324 may further include a second source electrode 362. The second source electrode 362 may receive a second power voltage from the driver part.

A width T1 of the first side portion 331 and the second side portion 332 may be greater than a width T2 of the body portion 320. The widths may be maximum heights taken in the first direction D1. Accordingly, the first side portion 331 may include a first protrusion 331a and a second protrusion 331b, and the second side portion 332 may include a third protrusion 332a and a fourth protrusion 332b.

The first protrusion 331a may protrude from a main body of the first side portion 331 in a first direction D1, and the second protrusion 331b may protrude from the main body of the first side portion 331 in an opposite direction to the first direction D1. The third protrusion 332a may protrude from a main body of the second side portion 332 in the first direction D1, and the fourth protrusion 332b may protrude from the main body of the second side portion 332 in the opposite direction to the first direction D1. Alternatively, only the first protrusion 331a may be protruded from the main body of the first side portion 331 and only the third protrusion 332a may be protruded from the main body of the second side portion 332.

The metal board 301 may be substantially an ‘H’ shape when the first side portion 331 includes the first protrusion 331a and the second protrusion 331b and the second side portion 332 includes the third protrusion 332a and the fourth protrusion 332b. Alternatively, the metal board 301 may be a one-side opened rectangle shape when the first side portion 331 includes only the first protrusion 331a and the second side portion 332 includes only the third protrusion 332a.

Accordingly, when the metal board 301 is assembled with the extrusion bar 230, the first protrusion 331a of the first side portion 331 and the third protrusion 332a of the second side portion 332 protruding further than the body portion 320 makes contact with the extrusion bar 230. A third surface of the metal board 301 may be defined as a collective surface along the lower dotted line indicating width T2, where such collective surface includes portions of the main bodies of first and second side portions 331 and 332, lower ends of the first and second insulation layers 341 and 342, and/or lower ends of the inner insulation member 350 and the body portion 320. The third surface corresponding to the first direction D1 of the metal board 301 does not make contact with the extrusion bar 230 and is electrically insulated from the extrusion bar 230.

The metal board 301 may include a conductive material such as aluminum having a relatively high heat conductivity compared with another metal material, so that the metal board 301 may dissipate heat generated by the light source to an outside effectively.

The mold frame 130 may be disposed over the optical sheets 210 and may be fixed to the lower receiving container 240, to support the display panel 120. The mold frame 130 fixes the light guide plate 220 and the optical sheets 210 to the lower receiving container 240.

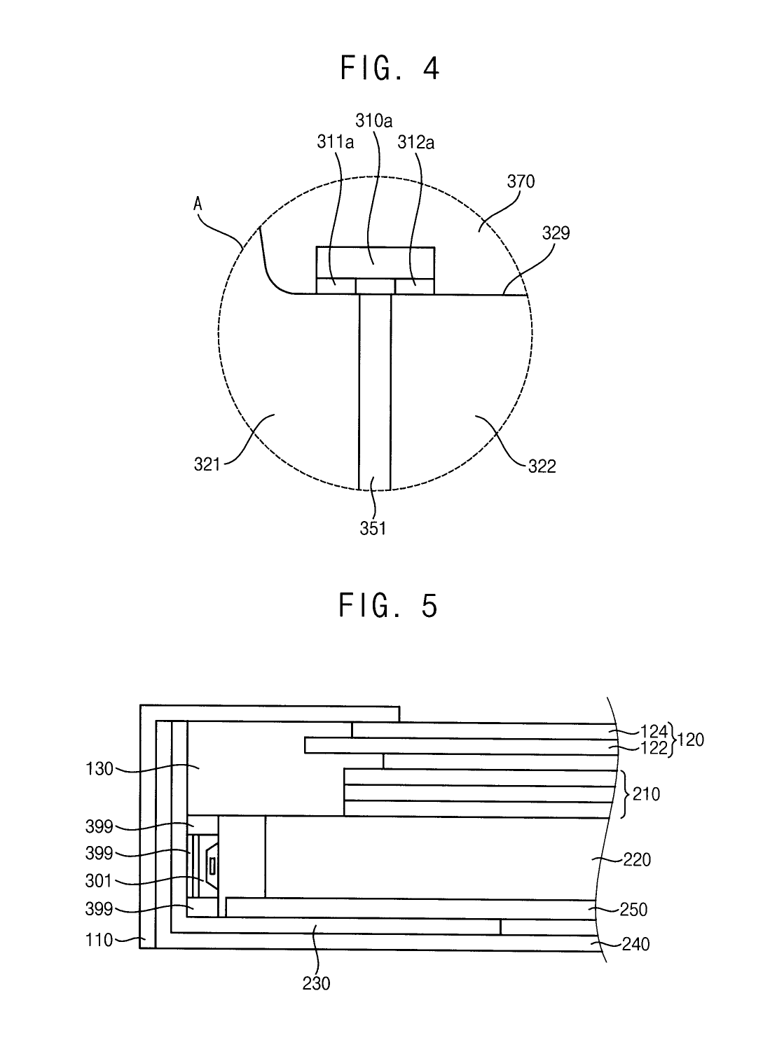

FIG. 4 is a cross-sectional view illustrating portion ‘A’ in FIG. 3.

Referring to FIGS. 2 to 4, the light source may be electrically connected to the metal board 301 and may receive a power voltage from the metal board 301 to emit light. The light source may include a light emitting diode.

The light sources may be in one-to-one correspondence with the inner insulation layers of the inner insulation member 350. The light source may include a light emitting portion, and a first electrode and a second electrode spaced apart from each other on the light emitting portion. The first electrode and the second electrode may be disposed at a lower surface of the light emitting portion of the light source. The first electrode may receive a first power voltage and the second electrode may receive a second power voltage.

A plurality of light sources may include a first light source 310a, a second light source 310b, a third light source 310c, . . . , and a n-th light source 310d. The first light source 310a may correspond to the first inner insulation layer 351. The second light source 310b may correspond to the second inner insulation layer 352. The third light source 310c may correspond to the third inner insulation layer 353. The n-th light source 310d may correspond to the n-th inner insulation layer 354. For convenience of illustration, the lead lines for reference numerals 310a, 310b, 310c and 310d extend from the light emitting portion of the respective light source, however, the respective light source collectively includes the light emitting portion and the first and second electrodes on the light emitting portion.

Referring again to FIG. 4, the first light source 310a may be disposed on and overlap the first portion 321 of the body portion 320, the first inner insulation layer 351 and the second portion 322 of the body portion 320. A first electrode 311a of the first light source 310a may be electrically connected to the first portion 321 of the body portion 320. A second electrode 312a of the first light source 310a may be electrically connected to the second portion 322 of the body portion 320.

A structure of the second light source 310b, the third light source 310c, . . . , and the n-th light source 310d is the same as that described with respect to the first light source 310a.

The second light source 310b may be disposed on and overlap the second portion 322 of the body portion 320, the second inner insulation layer 352 and the third portion 323 of the body portion 320. The first electrode of the second light source 310b may be electrically connected to the second portion 322 of the body portion 320. The second electrode of the second light source 310b may be electrically connected to the third portion 323 of the body portion.

The n-th light source 310d may be disposed on and overlap the n-th portion 325 of the body portion 320, the n-th inner insulation layer 354 and the (n+1)-th portion 324 of the body portion 320. The first electrode of the n-th light source 310d may be electrically connected to the n-th portion 325 of the body portion 320. The second electrode of the n-th light source 310d may be electrically connected to the (n+1)-th portion 324 of the body portion 320.

In the illustrated exemplary embodiment, for example, the first source electrode 361 may be electrically connected to the first portion 321 of the body portion 320, and the first portion 321 of the body portion 320 may be electrically connected to the second portion 322 of the body portion 320 through the first electrode 311a of the first light source 310a and the second electrode 312a of the first light source 310a. The second portion 322 of the body portion 320 may be electrically connected to the third portion 323 of the body portion 320 through the first electrode of the second light source 310b and the second electrode of the second light source 310b. The n-th portion 325 of the body portion 320 may be electrically connected to the (n+1)-th portion 324 of the body portion 320 through the first electrode of the n-th light source 310d and the second electrode of the n-th light source 310d. The (n+1)-th portion 324 of the body portion 320 may be electrically connected to the second source electrode 362. In addition, the remaining portions of the body portion 320 may be electrically connected in the same way.

Accordingly, the first source electrode 361 and the second source electrode 362 may be electrically connected to each other through the plural portions of the body portion 320 and the light sources, and may apply the power voltage to the light sources.

In addition, the first side portion 331 may be electrically insulated from the body portion 320 by the first insulation layer 341, and the second side portion 332 may be electrically insulated from the body portion 320 by the second insulation layer 342. Thus, the first side portion 331 and the second side portion 332 are electrically insulated from the first power voltage and the second power voltage.

Referring to FIG. 3, for example, the metal board 301 may have a first surface where the light source is disposed and a second surface opposite to the first surface. The first surface of the metal board 301 may be defined by a first surface of the body portion 320 on which the light source is disposed, and first surfaces of the first side portion 331 and the second side portion 332 on the same plane with the first surface of the body portion 320.

A sealing material 370 may be disposed on the body portion 320 and the light sources. The sealing material 370 may protect the light sources from an external impact. The sealing material 370 may include a chromaticity converting fluorescent material that converts the light provided from the light source to a white light.

In one exemplary embodiment, when the light source emits a blue light, the sealing material 370 may include a fluorescent material of mixed red and green colors. In another exemplary, when the light source emits a red light, the sealing material 370 may include a fluorescent material of mixed blue and green colors. In still another exemplary, when the light source emits a green light, the sealing material 370 may include a fluorescent material of mixed red and blue colors.

A receiving recess 329 may be defined in the metal board 301. The light source may be disposed in the receiving recess 329.

The receiving recess 329 may be recessed from the first surface of the metal board 301. In one exemplary embodiment, for example, the receiving recess 329 may be collectively defined in the body portion 320 from the first portion 321 of the body portion 320 to the (n+1)-th portion 324 of the body portion 320. Alternatively, the receiving recess 329 may be collectively defined in the first side portion 331, the body portion 320 and the second side portion 332.

With respect to the receiving recess 329, an inner space is defined by a bottom surface of the receiving recess 329 that is furthest from the first surface of the metal board 301, and by sidewall surfaces connected to the bottom surface and extending to the first surface of the metal board 301, as illustrated in the cross-sectional view of the metal board 301 in FIG. 3.

The receiving recess 329 is recessed from the first surface of the body portion 320 by a predetermined depth. Thus, the bottom surface of the receiving recess 329 and the sidewalls expose the first portion 321 of the body portion 320 to the (n+1)-th portion 324 of the body portion 320 and expose the first inner insulation layer 351 to the n-th inner insulation layer 354. Thus, the light source may be disposed on the bottom surface of the receiving recess 329 and may be electrically connected to the metal board 301.

The sealing material 370 may be disposed in the receiving recess 329. In one exemplary embodiment, for example, the receiving recess 329 may be filled with the sealing material 370 such that a first surface of the sealing material 370 is substantially coplanar with the first surface of the metal board 301.

The sidewalls of the receiving recess 329 may be extended from the bottom surface of the receiving recess 329 substantially vertically with respect to the bottom surface. Alternatively, the sidewalls of the receiving recess 329 may be extended from the bottom surface of the receiving recess 329 by a curved surface or an inclined (e.g., non-vertical) surface.

The insulation film 380 may be disposed on the second surface of the metal board 301 opposite to the first surface of the metal board 301. The insulation film 380 may be wider than the second surface of the body portion 320.

The insulation film 380 may electrically insulate the second surface of the body portion 320 through which the first power voltage and the second power voltage are applied to the first source electrode 361 and the second source electrode 362. Thus, the insulation film 380 may electrically insulate the second surface of the metal board 301 from the extrusion bar 230.

FIG. 5 is a cross-sectional view taken along line I-I′ in FIG. 1 according to the invention.

Referring to FIGS. 2 to 5, the extrusion bar 230 may secure the light emitting module 300. The extrusion bar 230 may be disposed between the light emitting module 300 and the lower receiving container 240 to secure the light emitting module 300 in the lower receiving container 240. Alternatively, the extrusion bar 230 may be an extended portion of the lower receiving container 240, such that the extrusion bar 230 and the lower receiving container 240 form a single, unitary, indivisible member.

The extrusion bar 230 may include a bottom surface horizontally connected to the lower receiving container 240 in a third direction D3 and a sidewall extending vertically from the bottom surface in the direction opposite to the first direction D1. The bottom surface of the extrusion bar 230 may be narrower than a bottom surface of the lower receiving container 240 in a second direction D2.

The light emitting module 300 may be combined with the extrusion bar 230 by a fixing member such as an adhesive tape 399. Alternatively, the light emitting module 300 may be combined with the extrusion bar 230 by a fastening member such as a screw or a bolt.

The insulation film 380 of the light emitting module 300 may be combined with the sidewall of the extrusion bar 230 by the adhesive tape 399, and the first protrusion 331a of the first side portion 331 and the third protrusion 332a of the second side portion 332 may make contact with the bottom surface of the extrusion bar 230. Thus, the body portion 320 is spaced apart from the sidewall of the extrusion bar 230 by the insulation film 380, and is spaced apart from the bottom surface of the extrusion bar 230 by the first protrusion 331a and the third protrusion 332a. In addition, the body portion 320 is spaced apart from the mold frame 130 by the second protrusion 331b and the fourth protrusion 332b, and is electrically insulated from the first side portion 331 and the second side portion 332 by the first insulation layer 341 and the second insulation layer 342, respectively. Thus, the light emitting module 300 is electrically insulated from the extrusion bar 230.

The light emitting module 300 may further include the adhesive tape 399 in a gap between the first protrusion 331a and the third protrusion 332a, and in a gap between the second protrusion 331b and the fourth protrusion 332b. Thus, the light emitting module 300 may be combined with and electrically insulated from the bottom surface of the extrusion bar 230 below the light emitting module 300 and the mold frame 130 above the light emitting module 300.

The extrusion bar 230 may includes a conductive material such as aluminum having a relatively high heat conductivity compared with another metal material, so that the extrusion bar 230 dissipates heat generated by the light emitting module 300 to an outside effectively.

The lower receiving container 240 may be combined with the upper receiving container 110 to receive the reflection sheet 250, the light guide plate 220, the light emitting module 300, the optical sheets 210 and the display panel 120 therein. The lower receiving container 240 has a wider planar area than that of the extrusion bar 230, and a strength greater than the extrusion bar 230. In one exemplary embodiment, for example, the lower receiving container 240 may include a galvanized steel sheet including zinc material.

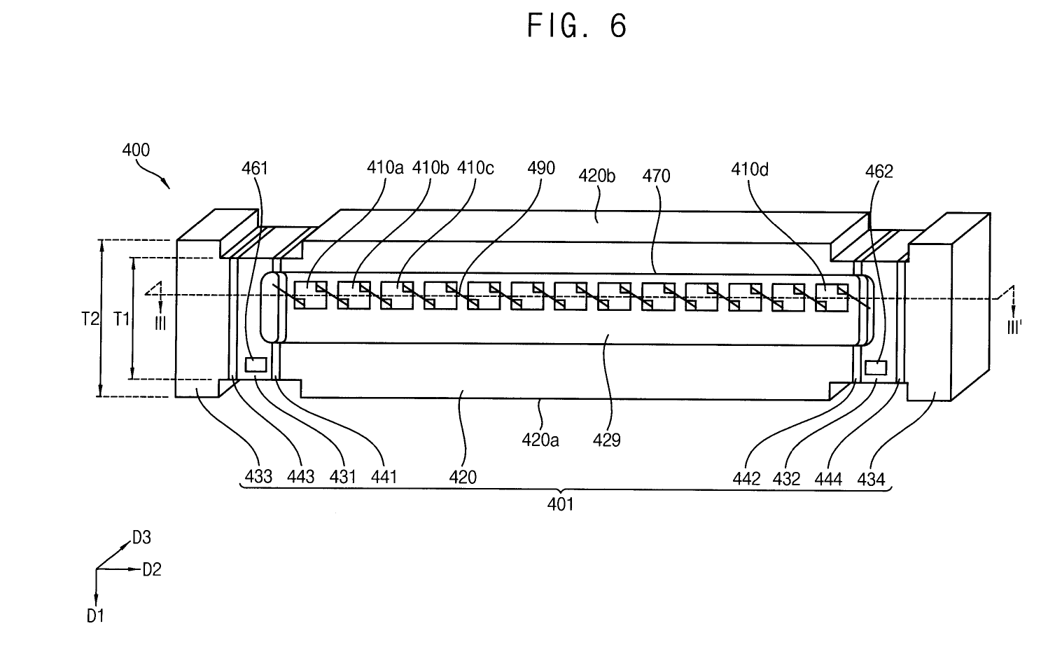

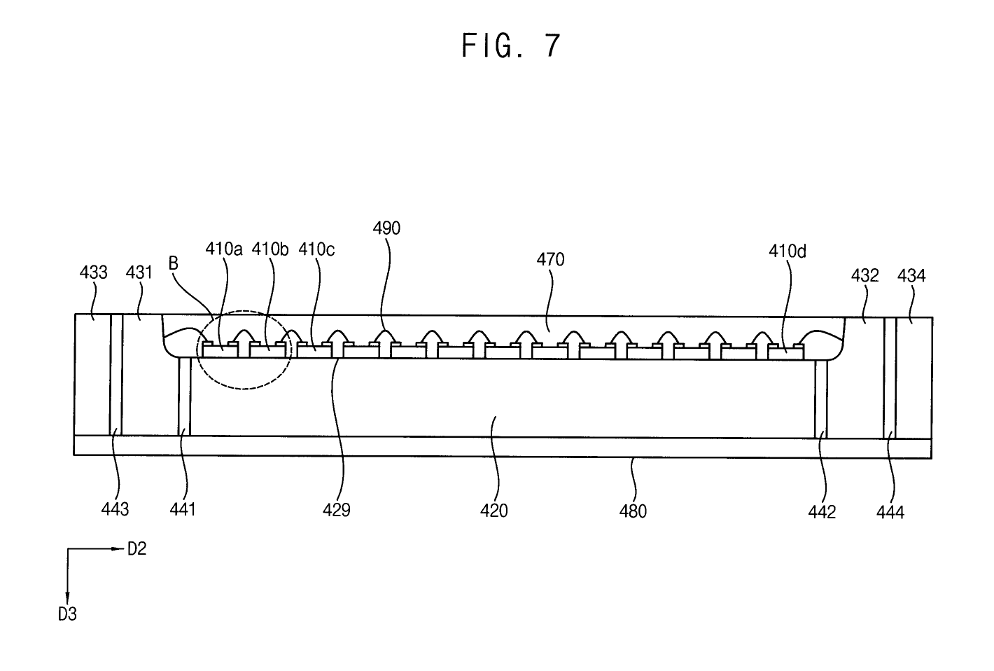

FIG. 6 is a perspective view illustrating another exemplary embodiment of a light emitting module in accordance with the invention. FIG. 7 is a cross-sectional view taken along the III-III′ in FIG. 6.

The display apparatus according to the illustrated exemplary embodiment is substantially the same as the display apparatus in FIG. 1 except for a light emitting module 400. Thus, the same reference numerals will be used to refer to same or like parts as those described in with reference to FIG. 1 and any further repetitive explanation concerning the above elements will be omitted.

Referring to FIGS. 1, 6 and 7, a display apparatus includes an upper receiving container 110, a display panel 120, mold frame 130 and a backlight assembly 200.

The backlight assembly 200 includes the light guide plate 220, optical sheets 210, a reflection sheet 250, a light emitting module 400, an extrusion bar 230 and a lower receiving container 240.

The light emitting module 400 includes a metal board 401, at least one light source, and an insulation film 480.

The light source may be secured to the metal board 401, and may be electrically connected to the metal board 401. The metal board 401 includes a body portion 420, a first side portion 431, a second side portion 432, a first insulation layer 441, and a second insulation layer 442.

The light source may be disposed on the body portion 420. The first side portion 431 may be disposed on a first end of the body portion 420, and the second side portion 432 may be disposed on a second end of the body portion 420. The second end of the body portion 420 is opposite to the first end of the body portion 420.

The first insulation layer 441 may be disposed between the body portion 420 and the first side portion 431. The first insulation layer 441 may electrically insulate the body portion 420 from the first side portion 431. The second insulation layer 442 may be disposed between the body portion 420 and the second side portion 432. The second insulation layer 442 may electrically insulate the body portion 420 from the second side portion 432.

The metal board 401 may further include a third side portion 433, a fourth side portion 434, a third insulation layer 443 and a fourth insulation layer 444.

The third side portion 433 may be disposed on an end of the first side portion 431, and the fourth side portion 434 may be disposed on an end of the second side portion 432.

The third insulation layer 443 may be disposed between the first side portion 431 and the third side portion 433. The third insulation layer 443 may electrically insulate the third side portion 433 from the first side portion 431. The fourth insulation layer 444 may be disposed between the second side portion 432 and the fourth side portion 434. The fourth insulation layer 444 may electrically insulate the fourth side portion 434 from the second side portion 432.

The third side portion 433, the third insulation layer 443, the first side portion 431, the first insulation layer 441, the body portion 420, the second insulation layer 442, the second side portion 432, the fourth insulation layer 444 and the fourth side portion 434 may be sequentially arranged in the above listed order along an extension direction of the metal board 401.

The first side portion 431 may further include a first source electrode 461. The first source electrode 461 may receive a first power voltage from a driver part (not shown).

The second side portion 432 may further include a second source electrode 462. The second source electrode 462 may receive a second power voltage from the driver part.

A width T1 of the first side portion 431 and the second side portion 432 may be less than a width T2 of the body portion 420. A step may be formed between the first side portion 431 and the second side portion 432, owing to the differences in widths T1 and T2. Accordingly, the body portion 420 may include a first protrusion 420a and a second protrusion 420b. Alternatively, the body portion 420 may include only the first protrusion 420a.

The first protrusion 420a may protrude from a main body of the body portion 420 in a first direction D1, and the second protrusion 420b may protrude from the main body of the body portion 420 in an opposite direction to the first direction D1.

The metal board 401 may be a ‘cross’ shape roughly when considering the main body of the body portion 420, and the first protrusion 420a and the second protrusion 420b. Alternatively, the metal board 401 may be a ‘T’ shape roughly when the only the first protrusion 420a protrudes from the main body of the body portion 420.

Accordingly, when the metal board 401 is assembled with the extrusion bar 230, the first protrusion 420a of the body portion 420 protruding further than the first side portion 431 and the second side portion 432, makes direct contact with the extrusion bar 230, thus a third surfaces corresponding to the first direction D1 of the first side portion 431 and second side portion 432 are spaced apart from the extrusion bar 230 and are electrically insulated from the extrusion bar 230.

The metal board 401 may include a conductive material such as aluminum having a relatively high heat conductivity compared with another metal material, so that the metal board 401 may dissipate heat generated by the light source to an outside effectively.

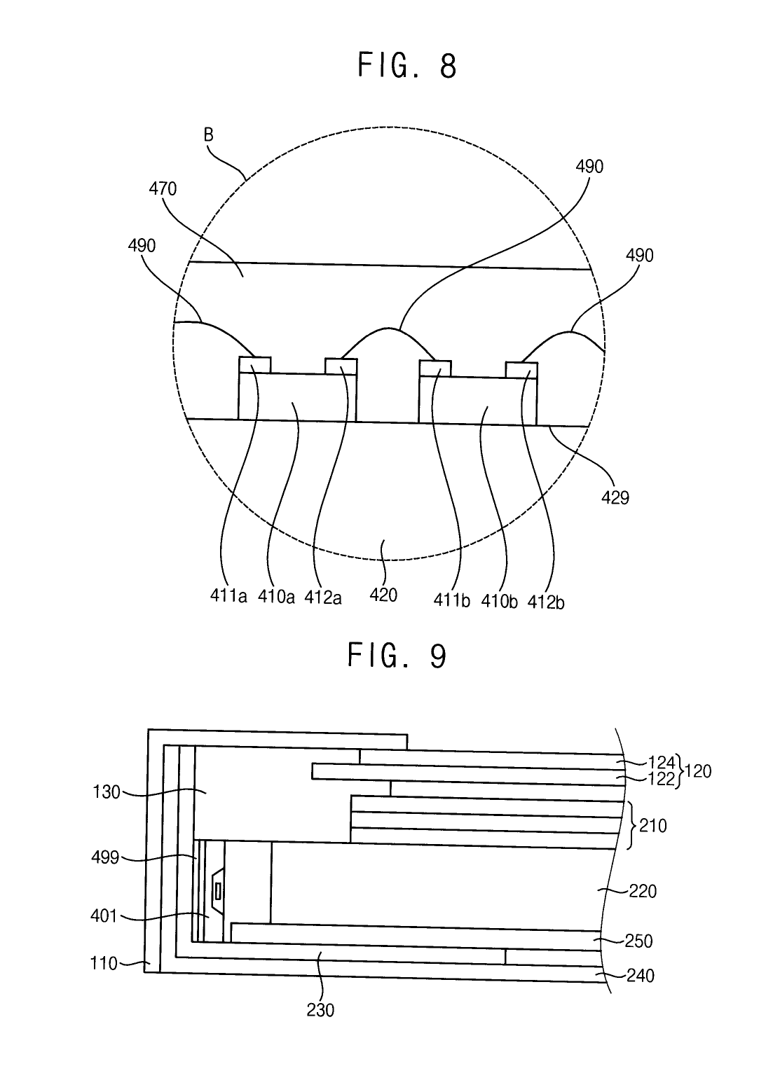

FIG. 8 is a cross-sectional view illustrating portion ‘B’ in FIG. 7.

Referring to FIGS. 6 to 8, the light source may be electrically connected to the metal board 401 and may receive a power voltage from the metal board 401 to emit light. The light source may include a light emitting diode.

The light source may include a light emitting portion, and a first electrode and a second electrode spaced apart from each other on the light emitting portion. The first electrode and the second electrode may be disposed on an upper surface of the light source. The first electrode may receive a first power voltage and the second electrode may receive a second power voltage.

A plurality of light sources may include a first light source 410a, a second light source 410b, a third light source 410c . . . , and a n-th light source 410d. The first light source 410a, the second light source 410b, the third light source 410c . . . , and the n-th light source 410d may be disposed on the body portion 420, and may be spaced apart from one another, and may be sequentially arranged in above listed order. For convenience of illustration, the lead lines for reference numerals 410a, 410b, 410c and 410d extend from the light emitting portion of the respective light source, however, the respective light source collectively includes the light emitting portion and the first and second electrodes on the light emitting portion.

The light sources may be electrically connected to each other by conductive connection members 490. The conductive connection member 490 may be spaced apart from the body portion 420, as illustrated in FIG. 7. A structure of the second light source 410b, the third light source 410c, . . . , and the n-th light source 410d is the same as that described with respect to the first light source 410a.

In one exemplary embodiment, for example, the first source electrode 461 may be electrically connected to the first side portion 431. The first side portion 431 may be electrically connected to the first light source 410a by a conductive connection member 490 which has a first end electrically connected to the first side portion 431 and a second end electrically connected to a first electrode 411a of the first light source 410a. The first light source 410a may be electrically connected to the second light source 410b by a conductive connection member 490 which has a first end electrically connected to a second electrode 412a of the first light source 410a and a second end electrically connected to a first electrode 411b of the second light source 410b. The second light source 410b may be electrically connected to the third light source 410c by a conductive connection member 490 which has a first end electrically connected to a second electrode 412b of the second light source 410b and a second end electrically connected to a first electrode of the third light source 410c. The n-th light source 410d may be electrically connected to the second side portion 432 by a conductive connection member 490 which has a first end electrically connected to a second electrode of the n-th light source 410d and a second end electrically connected to the second side portion 432. The second side portion 432 may be electrically connected to the second source electrode 462. In addition, the remaining light sources may be electrically connected in the same way.

Accordingly, the first source electrode 461 and the second source electrode 462 may be electrically connected to each other through the plural light sources and the conductive connection members 490, and may apply the power voltage to the light sources.

The body portion 420 may be electrically insulated from the first side portion 431 by the first insulation layer 441, and may be electrically insulated from the second side portion 432 by the second insulation layer 442. In addition, the body portion 420 may be spaced apart from the first electrode and the second electrode of the light source, due to the first electrode and the second electrode being disposed on the upper surface (e.g., a distal end) of the light source, and may be electrically insulated from the first electrode and the second electrode of the light source. In addition, the body portion 420 may be electrically insulated from the conductive connection member 490. Accordingly, the body portion 420 may be electrically insulated from the first power voltage and the second power voltage.

Referring to FIG. 7, the metal board 401 may have a first surface where the light source is disposed and a second surface opposite to the first surface. The first surface of the metal board 401 may be defined by a first surface of the body portion 420 on which the light source is disposed, first surfaces of the first side portion 431, the second side portion 432, the third side portion 433 and the fourth side portion 434 on the same plane with the first surface of the body portion 420.

A sealing material 470 may be disposed on the body portion 420 and the light sources. The sealing material 470 may protect the light sources from an external impact. The sealing material 470 may include a chromaticity converting fluorescent material that converts the light provided from the light source to a white light.

In one exemplary embodiment, when the light source emits a blue light, the sealing material 470 may include a fluorescent material of mixed red and green colors. In another exemplary, when the light source emits a red light, the sealing material 470 may include a fluorescent material of mixed blue and green colors. In still another exemplary embodiment, when the light source emits a green light, the sealing material 470 may include a fluorescent material of mixed red and blue colors.

A receiving recess 420 may be defined in the metal board 410. The light source may be disposed in the receiving recess 429.

The receiving recess 429 may be recessed from the first surface of the metal board 401. In one exemplary embodiment, for example, the receiving recess 429 may be collectively defined in the metal board 401 from the first side portion 431 to the second side portion 432.

With respect to the receiving recess 429, an inner space is defined by a bottom surface of the receiving recess 429 that is furthest from the first surface of the metal board 401, and by sidewall surfaces connected to the bottom surface and extending to the first surface of the metal board 301, as illustrated in the cross-sectional view of the metal board 401 in FIG. 7.

The receiving recess 429 is recessed from the first surface of the metal board 401 by a predetermined depth. Thus, the bottom surface of the receiving recess 429 and the sidewalls expose the first side portion 431, first insulation layer 441, body portion 420, second insulation layer 442 and the second side portion 432. Thus, the light source may be disposed on the bottom surface of the receiving recess 429 and may be electrically connected to the metal board 401.

The sealing material 470 may be disposed in the receiving recess 429. In one exemplary embodiment, for example, the receiving recess 429 may be filled with the sealing material 470 such that a first surface of the sealing material 470 is substantially coplanar with the first surface of the metal board 401.

The sidewalls of the receiving recess 429 may be extended from the bottom surface of the receiving recess 429 substantially vertically with respect to the bottom surface. Alternatively, the sidewalls of the receiving recess 429 may be extended from the bottom surface of the receiving recess 429 by a curved surface or an inclined (e.g., non-vertical) surface.

The insulation film 480 may be disposed on the second surface of the metal board 401 opposite to the first surface of the metal board 401. The insulation film 480 may cover the second surface of the metal board 401 corresponding to the third side portion 433, the third insulation layer 443, the first side portion 431, the first insulation layer 441, the body portion 420, the second insulation layer 442, the second side portion 432, the fourth insulation layer 444 and the fourth side portion 434. Alternatively, the insulation film 480 may cover the second surface of the metal board 401 corresponding to elements only between and including the first side portion 431 and the second side portion 432.

The insulation film 480 may electrically insulate the second surfaces of the first side portion 431 and the second side portion 432, where the first power voltage and the second power voltage are applied through the first source electrode 461 and the second source electrode 462. Thus, the insulation film 480 may electrically insulate the second surface of the metal board 401 from the extrusion bar 230.

FIG. 9 is a cross-sectional view taken along line I-I′ in FIG. 1 according to the invention.

Referring to FIGS. 6 to 9, the extrusion bar 230 may secure the light emitting module 400. The extrusion bar 230 may be disposed between the light emitting module 400 and the lower receiving container 240 to secure the light emitting module 300 in the lower receiving container 240. Alternatively, the extrusion bar 230 may be an extending portion of the lower receiving container 240 such that the extrusion bar 230 and the lower receiving container 240 form a single, unitary, indivisible member.

The extrusion bar 230 may include a bottom surface horizontally connected to the lower receiving container 240 and a sidewall extending vertically from the bottom surface. The bottom surface of the extrusion bar 230 may be narrower than a bottom surface of the lower receiving container 240.

The light emitting module 400 may be combined with the extrusion bar 230 by a fixing member such as an adhesive tape 499. Alternatively, the light emitting module 400 may be combined with the extrusion bar 230 by a fastening member such as a screw or a bolt.

The insulation film 480 of the light emitting module 400 may be combined with the sidewall of the extrusion bar 230 by the adhesive tape 499, and the first protrusion 420a of the body portion 420 may make contact with the bottom surface of the extrusion bar 230. Thus, the first side portion 431 and the second side portion 432 are spaced apart from the sidewall of the extrusion bar 230 by the insulation film 480, and are spaced apart from the bottom surface of the extrusion bar 230 by the first protrusion 420a. In addition, the first side portion 431 and the second side portion 432 are spaced apart from the mold frame 130 by the second protrusion 420b. The first side portion 431 is electrically insulated from the body portion 420 by the first insulation layer 441, and is electrically insulated from the third side portion 433 by the third insulation layer 443. The second side portion 432 is electrically insulated from the body portion 420 by the second insulation layer 442, and is electrically insulated from the fourth side portion 434 by the fourth insulation layer 444.

Accordingly, the light emitting module 400 is electrically insulated from the extrusion bar 230 and the mold frame 130.

The extrusion bar 230 may includes a conductive material such as aluminum having a relatively high heat conductivity compared with another metal material, so that the extrusion bar 230 dissipates heat generated by the light emitting module 400 to an outside effectively.

According to one or more of the illustrated exemplary embodiments, a heat dissipation of the light emitting module may be improved and the light emitting module may be electrically insulated from the extrusion bar.

The foregoing is illustrative of the invention and is not to be construed as limiting thereof. Although a few exemplary embodiments of the invention have been described, those skilled in the art will readily appreciate that many modifications are possible in the exemplary embodiments without materially departing from the novel teachings and advantages of the invention. Accordingly, all such modifications are intended to be included within the scope of the invention as defined in the claims. In the claims, means-plus-function clauses are intended to cover the structures described herein as performing the recited function and not only structural equivalents but also equivalent structures. Therefore, it is to be understood that the foregoing is illustrative of the invention and is not to be construed as limited to the specific exemplary embodiments disclosed, and that modifications to the disclosed exemplary embodiments, as well as other exemplary embodiments, are intended to be included within the scope of the appended claims. The invention is defined by the following claims, with equivalents of the claims to be included therein.

What is claimed is:

1. A light emitting module comprising:
a first light source which is configured to generate and emit light;
a second light source which is configured to generate and emit light and is spaced apart from the first light source; and
a metal board which is electrically connected to the first light source and the second light source,
wherein the metal board comprises:
a body portion upon which the first light source and the second light source are disposed;
a first side portion on a first end of the body portion;
a second side portion on a second end of the body portion opposite to the first end of the body portion;
a first insulation layer which is between the body portion and the first side portion and insulates the body portion from the first side portion; and
a second insulation layer which is between the body portion and the second side portion and insulates the body portion from the second side portion.

2. The light emitting module of claim 1, further comprising an insulation film on a second surface of the metal board opposite a first surface of the metal board on which the first light source and the second light source are disposed.

3. The light emitting module of claim 1, further comprising a sealing material which covers the first light source and the second light source, and is configured to convert a chromaticity of the light emitted by the first light source and the second light source,
wherein the sealing material is on the first light source, the second light source and the metal board.

4. The light emitting module of claim 1, wherein
the body portion comprises a first inner insulation layer and a second insulation layer, wherein the first inner insulation layer and the second insulation layer divide the body portion into plural portions,
the first light source comprises a first light emitting portion, and a first electrode and a second electrode between the first light emitting portion and the body portion,
the second light source comprises a second light emitting portion, and a first electrode and a second electrode between the second light emitting portion and the body portion,
the first electrode of the first light source is electrically connected to a portion of the body portion between the first insulation layer and the first inner insulation layer,
the second electrode of the first light source is electrically connected to a portion of the body portion between the first inner insulation layer and the second inner insulation layer,
the first electrode of the second light source is electrically connected to the portion of the body portion between the first inner insulation layer and the second inner insulation layer, and
the second electrode of the second light source is electrically connected to a portion of the body portion between the second inner insulation layer and the second insulation layer.

5. The light emitting module of claim 4, wherein
the body portion further comprises:
a first source electrode on the portion of the body portion between the first insulation layer and the first inner insulation layer; and
a second source electrode on the portion of the body portion between the second inner insulation layer and the second insulation layer,
the first source electrode receives a first power voltage, and
the second source electrode receives a second power voltage.

6. The light emitting module of claim 4, wherein
a width of the first side portion and a width of the second side portion are greater than a width of the body portion, and
an extending direction of the width of the first side portion, an extending direction of the width of the second side portion and an extending direction of the width of the body portion are parallel with respective extending directions of the first insulation layer and the second insulation layer.

7. The light emitting module of claim 4, wherein the first inner insulation layer and the second inner insulation layer are parallel with those of the first insulation layer and the second insulation layer, and are sequentially arranged at constant intervals in a length direction of the metal board.

8. The light emitting module of claim 4, further comprising a third light source which is configured to generate and emit light, is between the first light source and the second light source, and spaced apart from the first light source and the second light source,
wherein
the third light source comprises a third light emitting portion, and a first electrode and a second electrode between the third light emitting portion and the body portion,
the body portion further comprises a third inner insulation layer between the first inner insulation layer and the second inner insulation layer,
the third inner insulation layer is parallel with the first inner insulation layer and the second inner insulation layer, and divides the body portion between the first inner insulation layer and the second inner insulation layer into the plural portions,
the first electrode of the third light source is electrically connected to a portion of the body portion between the first inner insulation layer and the third inner insulation layer, and
the second electrode of the third light source is electrically connected to a portion of the body portion between the second inner insulation layer and the third inner insulation layer.

9. The light emitting module of claim 1, wherein
the first light source comprises a first light emitting portion on the body portion, and a first electrode and a second electrode at a distal end of the first light emitting portion,
the second light source comprises a second light emitting portion on the body portion, and a first electrode and a second electrode at a distal end of the second light emitting portion,
the first electrode of the first light source is electrically connected to the first side portion via a first conductive connection member therebetween,
the second electrode of the first light source is electrically connected to the first electrode of the second light source via a second conductive connection member therebetween, and
the second electrode of the second light source is electrically connected to the second side portion via a third conductive connection member therebetween.

10. The light emitting module of claim 9, wherein the metal board further comprises:
a first source electrode on the first side portion; and
a second source electrode on the second side portion,
wherein
the first source electrode receives a first power voltage, and
the second source electrode receives a second power voltage.

11. The light emitting module of claim 9, wherein
a width of the first side portion and a width of the second side portion are less than a width of the body portion, and
an extending direction of the width of the first side portion, an extending direction of the width of the second side portion and an extending direction of the width of the body portion are parallel with respective extending directions of the first insulation layer and the second insulation layer.

12. The light emitting module of claim 9, wherein the metal board further comprises:
a third side portion on an end portion of the first side portion;
a third insulation layer which is between the first side portion and the third side portion, and insulates the third side portion from the first side portion;
a fourth side portion on an end portion of the second side portion; and
a fourth insulation layer which is between the second side portion and the fourth side portion, and insulates the fourth side portion from the second side portion.

13. The light emitting module of claim 1, further comprising a third light source which is configured to generate and emit light, is between the first light source and the second light source, and spaced apart from the first light source and the second light source,
wherein
the first light source, the second light source and the third light source each comprises a light emitting portion on the body portion, and a first electrode and a second electrode at a distal end of the light emitting portion,
the first electrode of the first light source is electrically connected to the first side portion via a first conductive connection member therebetween,
the second electrode of the first light source is electrically connected to the first electrode of the third light source via a second conductive connection member therebetween,
the second electrode of the third light source is electrically connected to the first electrode of the second light source via a third conductive connection member therebetween, and
the second electrode of the second light source is electrically connected to the second side portion via a fourth conductive connection member therebetween.

14. A backlight assembly comprising:
a light emitting module comprising:
a first light source which is configured to generate and emit light;
a second light source which is configured to generate and emit light, and is spaced apart from the first light source;
a metal board which is electrically connected with the first light source and the second light source;
an insulation film on a second surface of the metal board opposite a first surface of the metal board on which the first light source and the second light source are disposed; and
a sealing material which covers the first light source and the second light source, and is configured to convert a chromaticity of the light emitted by the first light source and the second light source,
a light guide plate comprising a light incident surface and a light exiting surface; and
an extrusion bar to which the light emitting module is secured,
wherein the metal board comprises:
a body portion upon which the first light source and the second light source are disposed;
a first side portion on a first end of the body portion;
a second side portion on a second end of the body portion opposite to the first end of the body portion;
a first insulation layer which is between the body portion and the first side portion, and electrically insulates the body portion from the first side portion; and
a second insulation layer which is between the body portion and the second side portion, and electrically insulates the body portion from the second side portion.

15. The backlight assembly of claim 14, wherein the body portion comprises:
a first inner insulation layer; and
a second inner insulation layer,
wherein
the first inner insulation layer and the second inner insulation layer divide the body portion into plural portions,
the first light source comprises a first light emitting portion, and a first electrode and a second electrode between the first light emitting portion and the body portion,
the second light source comprises a second light emitting portion, and a first electrode and a second electrode between the second light emitting portion and the body portion,
the first electrode of the first light source is electrically connected to a portion of the body portion between the first insulation layer and the first inner insulation layer,
the second electrode of the first light source is electrically connected to a portion of the body portion between the first inner insulation layer and the second inner insulation layer,
the first electrode of the second light source is electrically connected to the portion of the body portion between the first inner insulation layer and the second inner insulation layer, and
the second electrode of the second light source is electrically connected to a portion of the body portion between the second inner insulation layer and the second insulation layer.

16. The backlight assembly of claim 15, wherein the body portion further comprises:
a first source electrode on the portion of the body portion between the first insulation layer and the first inner insulation layer; and
a second source electrode on the portion of the body portion between the second insulation layer and the second inner insulation layer,
wherein
the first source electrode receives a first power voltage, and
the second source electrode receives a second power voltage.

17. The backlight assembly of claim 15, wherein
a width of the first side portion and a width of the second side portion are greater than a width of the body portion, with respect to a same surface of the extrusion bar, and
an extending direction of the width of the first side portion, an extending direction of the width of the second side portion and an extending direction of the width of the body portion are parallel with respective extending directions of the first insulation layer and the second insulation layer.

18. The backlight assembly of claim 14, wherein
the first light source and the second light source each comprises a light emitting portion on the body portion, and a first electrode and a second electrode at a distal end of the light emitting portion,
the first electrode of the first light source is electrically connected to the first side portion via a first conductive connection member therebetween,
the second electrode of the first light source is electrically connected to the first electrode of the second light source via a second conductive connection member therebetween, and
the second electrode of the second light source is electrically connected to the second side portion via a third conductive connection member therebetween.

19. The backlight assembly of claim 18, wherein the metal board further comprises:
a first source electrode on the first side portion; and
a second source electrode on the second side portion,
wherein
the first source electrode receives a first power voltage, and
the second source electrode receives a second power voltage.

20. The backlight assembly of claim 18, wherein a width of the first side portion and a width of the second side portion are less than a width of the body portion, with respect to a same surface of the extrusion bar, and
an extending direction of the width of the first side portion, an extending direction of the width of the second side portion and an extending direction of the width of the body portion are parallel with respective extending directions of the first insulation layer and the second insulation layer.
